(19) United States
(12) Patent Application Publication
(10) Pub. No.: US 2015/0348140 A1
(43) Pub. Date: Dec. 3, 2015

(54) CARD-LINKED OFFER BASED ON DEAL CONSTRUCT

(71) Applicant: Edo Interactive, Inc., Nashville, TN (US)

(72) Inventor: Christopher Dominic CAMPBELL, Chicago, IL (US)

(73) Assignee: Edo Interactive, Inc., Nashville, TN (US)

(21) Appl. No.: 14/290,617

(22) Filed: May 29, 2014

(51) Int. Cl. G06Q 30/02

(52) U.S. Cl. CPC G06Q 30/0276

(57) ABSTRACT

A system and machine-implemented method for determining and recommending a deal construct specifying a card-linked offer to cardholders is provided. A deal construct for a card-linked offer deal may be determined based on historical data from previously executed card-linked offer deals and selected deal construct parameters. A predictive model based on performance of card-linked offer deals for similar businesses may be used to determine an optimal range of deal constructs to be offered to an advertiser.

### BACKGROUND

The present disclosure generally relates to providing card-linked offer discounts or deals and, in particular, to improving the performance of card-linked offer discounts, coupons or deals through deal constructs that optimize performance and return on investment (ROI) based on one or more parameters.

A card-linked offer provider typically has clients (e.g., advertisers) that wish to have one or more card-linked offer deals that provide a financial incentive or rebate to a user's card (e.g., credit card, debit card) based on a purchase transaction. An advertiser may negotiate with a card-linked offer provider to have a particular discount or deal sent to a group of potential and/or current customers that are cardholders. The deal may be based on standard deal values or based on past cardholder behaviors and preferences.

### SUMMARY

The disclosed subject matter relates to a computer implemented method for recommending a card-linked offer. The method includes receiving, at a server, a request to create a card-linked offer deal. The method also includes obtaining, from a database, historical data from previously executed card-linked offer deals. The method further includes determining, by one or more processors, one or more deal construct parameters applicable to the requested card-linked offer deal. The method also includes determining, by one or more processors, one or more deal constructs based on the historical data and the one or more deal construct parameters, wherein a deal construct specifies a proposed card-linked offer to be provided to cardholders associated with at least one card issuer. The method further includes recommending at least one of the determined deal constructs to the requestor.

The disclosed subject matter further relates to a system for recommending a card-linked offer. The system includes a server computer for determining, recommending and executing a deal construct, wherein the deal construct specifies a proposed card-linked offer deal. The system also includes a first database in communication with the server computer, the first database comprising historical data from previously executed card-linked offer deals. The system further includes a second database in communication with the server computer, the second database comprising one or more deal construct parameters, wherein the server computer obtains historical data from the first database, wherein the server computer assigns one or more deal construct parameters from the second database, wherein the server computer determines one or more deal constructs associated with an advertiser based on the obtained historical data and the assigned deal construct parameters, wherein the server computer recommends at least one of the determined deal constructs to the advertiser, and wherein the server computer sends a communication of a card-linked offer to a target group of cardholders based on a selection of a deal construct by the advertiser.

The disclosed subject matter also relates to a non-transitory machine-readable storage medium comprising machine readable instructions for causing a processor to execute a method for recommending a card-linked offer. The method includes receiving, by one or more processors, a request to create a card-linked offer deal. The method also includes obtaining, from a database, historical data from previously executed card-linked offer deals. The method further includes determining, by one or more processors, one or more deal construct parameters applicable to the requested card-linked offer deal. The method also includes determining, by one or more processors, one or more deal constructs based on the historical data and the one or more deal construct parameters, wherein a deal construct specifies a proposed card-linked offer to be provided to cardholders associated with at least one card issuer. The method further includes recommending at least one of the determined deal constructs to the requestor.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example of a deal construct recommendation system.

FIG. 2 illustrates another example of a deal construct recommendation system.

FIG. 3 illustrates yet another example of a deal construct recommendation system.

FIG. 4 illustrates an example deal menu.

FIG. 5 illustrates an example deal construct interface.

FIG. 6 illustrates an example process for providing a deal construct recommendation.

FIG. 7 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein. In some instances, structures and components are shown in block diagram form in order to avoid obscuring the concepts of the subject technology.

A card-linked offer is an incentive offer that is linked to the use of a financial card, such as a credit card or a debit card. For example, an offer to receive a redemption of 10% of a purchase up to $20.00 on a particular card used at a specific merchant (e.g., advertiser) may be sent out to a target group of cardholders. Here, any of the target group of cardholders that uses that particular card at the specific advertiser will receive the redemption.

Card-linked offers may be structured in various formats. For example, an insertion order (IO) is a contract with an advertiser that specifies the details of the advertising program. An IO may include the total dollar value and duration of the spend, but will not include the specific deals that will be run. A deal relates to an IO, specifying monetary terms (e.g., budget, construct) and targeting parameters. In some cases (e.g., local) each IO only has one deal, but in other cases (e.g., national) an IO may have more than one deal associated with it. These deals may have different start/end dates, budgets, and constructs, or they can all be the same. Deals may be differentiated by how the deals are targeted (e.g., lapsed customer, loyal customer, new customer, geography). A network deal is a deal specific to a specific financial institution (FI) network in which the deal is scheduled to run. Each deal may have multiple network deals associated with it, as a deal may run multiple times on multiple FI networks. Redemptions (and therefore spend, revenue, etc.) are tracked on each network deal, and then rolled up to the deal level to calculate totals and budget burn-down (e.g., how much and how fast the budget is spent). Attribution (e.g., determining that a user actually saw the card-linked offer prior to making a purchase that triggers a redemption) may also be tracked on each deal, thereby providing a measurement of the effectiveness of the card-linked offer in driving user behavior. A campaign may be used to indicate any of an IO, a deal or a network deal.

Another example format is for an advertiser to sign an initial usage agreement that outlines the general terms and conditions for the services to be provided by a card-linked offer provider. Subsequently, when an advertiser submits a particular campaign to be carried out by the card-linked offer provider, acceptance for liability on the part of the advertiser stemming from the card-linked offer is automatically triggered. Such liability may be the liability for the offer value (e.g., payment of the redeemed offers), commissions or other fees due to the card-linked offer provider, and the like.

A card-linked offer environment includes advertisers that are interested in providing incentives to cardholders in order to obtain new cardholder customers, increase existing cardholder customer loyalty and increase the amount cardholders spend on the advertiser's products or services. For example, an advertiser may be a local coffee shop that is interested in providing $1.00 off of any purchase of $5.00 or more made by a cardholder in order to attract new cardholder customers and reward existing cardholder customers. The card-linked offer environment also includes financial institutions or card issuers that provide the financial cards to cardholders, such as banks, credit unions and the like. A card-linked offer provider may act as an exchange or a middleman to facilitate matching up card issuers with advertisers. Either or both the card-linked offer provider and the card issuer have a database of cardholders from which a targeted group of cardholders may be chosen to receive a particular offer. The card-linked offer provider may utilize a deal construct, which is a set of parameters that are used to frame a card-linked offer.

The choosing of a particular card-linked offer to be sent to a targeted group of cardholders may be made directly by the advertiser or suggested by the card-linked offer provider. For example, the advertiser may decide that a previously run card-linked offer was successful enough to simply run again with the same or different targeted group of cardholders. Also, the card-linked offer provider may offer a set of standard card-linked offers and the advertiser may simply choose one or more. In addition, the card-linked provider may provide suggested card-linked offers for the advertiser to choose from. The suggested card-linked offers may be based on the card-linked provider's experience with the same advertiser or experience with other advertisers in a similar business environment. Negotiations may be conducted between the advertiser and the card-linked offer provider for each card-linked offer to be sent out on behalf of the advertiser. The card-linked offer provider's suggestions may be provided by a representative (e.g., account manager), who might have different experiences than other representatives of the card-linked offer provider. The process of reviewing an advertiser's history and interest for new card-linked offers may be time consuming and results may vary depending upon the people involved in the deal. Further, a card-linked offer provider may have many advertisers with each advertiser expecting to do several different card-linked offer deals in a period of time.

As noted above, managing the recommendation and execution of a plurality of card-linked offers is complex and cumbersome, typically requiring manual decision making for selection of every card-linked offer that is to be sent out. For example, a card-linked offer provider may have 800 card-linked offer deals at a particular time, each card-linked offer deal having a specific set of parameters associated with it. Determining the specific parameters for so many card-linked offer deals manually may be difficult and may lead to ineffective results when the card-linked offers are flighted (e.g., sent out to the target cardholders). It is desired to provide an automated and efficient way of recommending deal constructs optimal card-linked offers to targeted cardholders.

The subject technology provides for a system that uses historical data from previously flighted card-linked offers and/or one or more deal construct parameters to automatically and efficiently provide recommendations of one or more card-linked offers that are most likely to meet or exceed an advertiser's criteria. The historical data may include previously flighted card-linked offers executed by the card-linked offer provider for the same advertiser, other advertisers within the same industry as the requesting advertiser, or advertisers that are not within the same industry as the requesting advertiser. For example, the card-linked offer provider may have flighted or run 20 previous card-linked offers for the requesting advertiser, which may be analyzed to determine which of the 20 previous card-linked offers is most relevant to the advertiser's current need based on variables or deal construct parameters, such as the advertiser's budget for the card-linked offer, the return on investment (ROI) desired, the number of redemptions by cardholders desired, average order value (AOV), and the like. The card-linked offer provider may then recommend one or multiple deal constructs to the requesting advertiser based on the analysis.

In addition to the historical card-linked offer data for the requesting advertiser, the card-linked provider may have historical card-linked offer data for other advertisers, some of which may be in the same industry as the requesting advertiser and others that may be in a different industry, but are relevant based on other factors. For example, the requesting advertiser may be a national chain of fast food hamburger restaurants and the card-linked offer provider may have flighted multiple card-linked offers for another national chain of fast food hamburger restaurants. Here, the card-linked offer provider may analyze the performance of the other chain's card-linked offer deals and structure a deal construct based on the analysis and the deal construct parameters provided by the requesting advertiser. For example, based on the spend budget and the desired ROI provided by the requesting advertiser, the card-linked offer provider may determine that a card-linked offer of $1.00 off of a $5.00 purchase was very successful for the other hamburger restaurant chain and had similar deal construct parameters. Such analysis may be done by a predictive modeling module or process.

Each deal construct may be based on one or more deal construct parameters, which may be numerous and varied. For example, some deal construct parameters may include an advertiser's identity, an advertiser's industry and an advertiser's geography. Here, an industry designation or classification may be provided by the requesting advertiser or by the card-linked offer provider. As another example, some deal construct parameters may include an advertiser's historical card-linked offer performance, a historical card-linked offer performance of another advertiser, a historical card-linked offer performance of an advertiser's industry, and a historical card-linked offer performance of an advertiser's geography. Yet further examples of deal construct parameters may include a spend budget, a redemption rate, a level of increase for an average cardholder spend, and a time frame.

In example aspects, the deal construct parameters may be used to provide several deal constructs as pre-set deals for the requesting advertiser or the requesting advertiser's industry. The pre-set deals may be presented to the requesting advertiser on a deal menu. For example, the requesting advertiser may log in to the card-linked offer provider's system (e.g., Java based, web accessible system), enter or select an industry classification, and automatically receive a deal menu displaying several pre-set deals (e.g., deal constructs) to choose from. The requesting advertiser may choose one of the pre-set deals or use an average basket or ticket size option to create a non-standard deal construct.

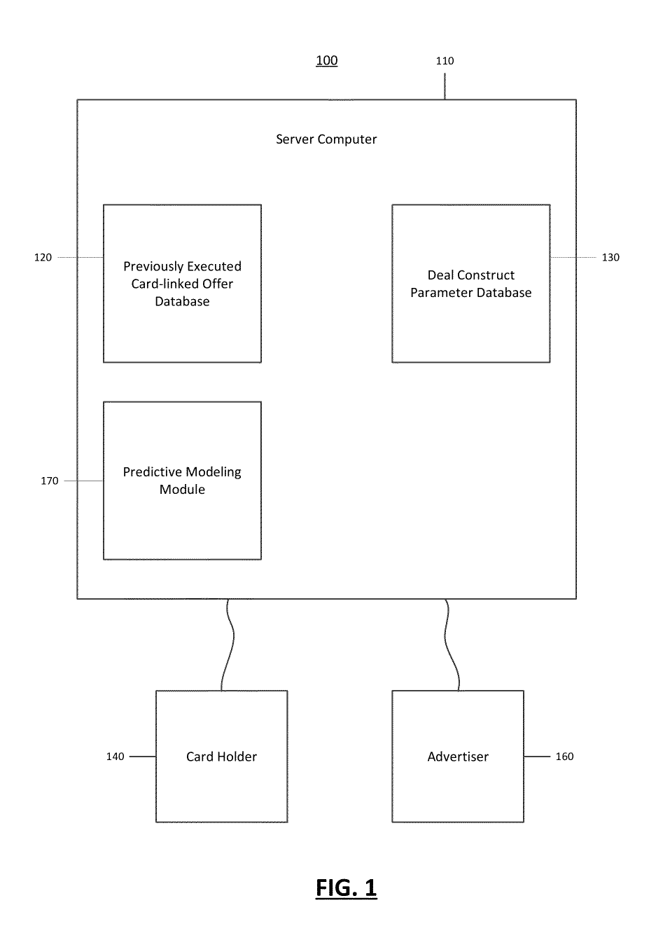

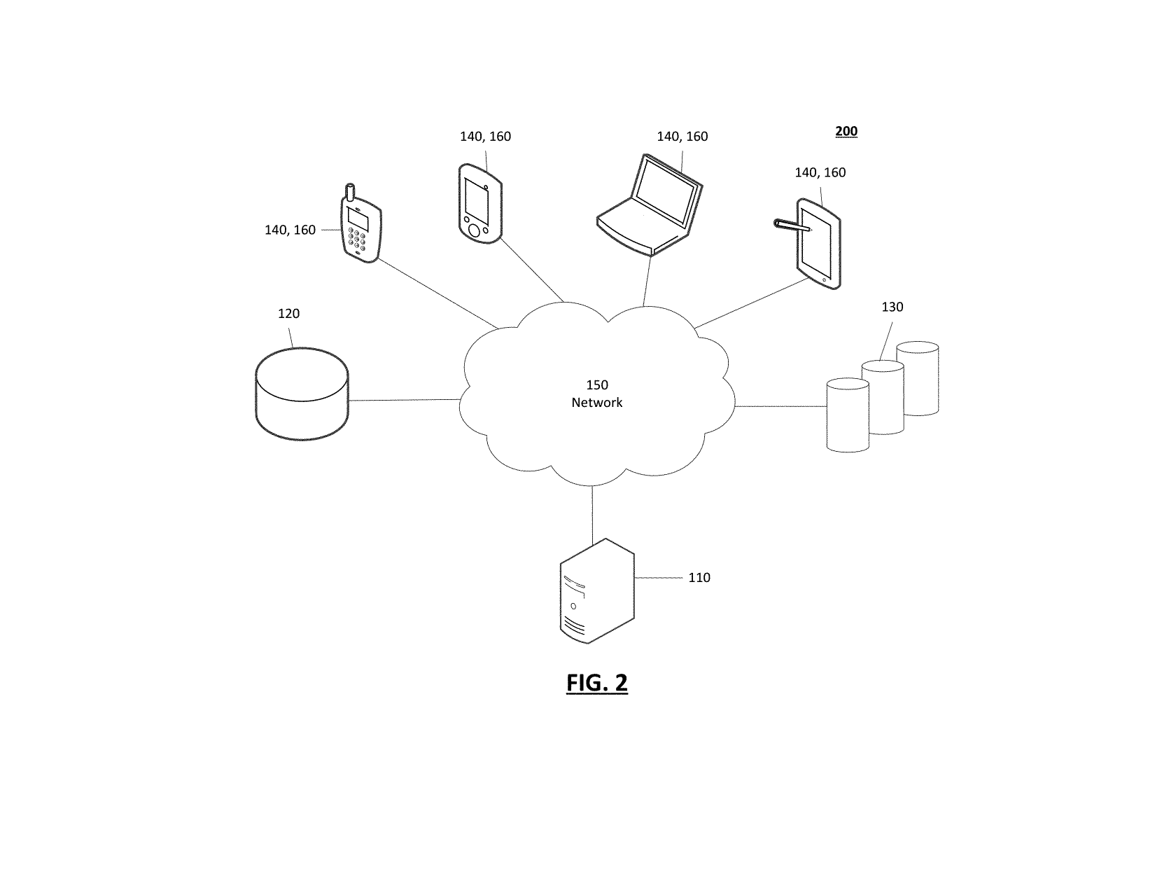

FIG. 1 illustrates an example of a card-linked offer system 100 having a server computer 110 that includes an executed card-linked offer information database 120 and a deal construct parameter database 130. Executed card-linked offer information database 120 and deal construct parameter database 130 may both be part of an integrated database, they may be separate and distinct databases on the same system or they may be separate and distinct databases on different systems as shown in FIG. 2. The server computer 110 may be in communication with one or more advertiser devices 160 and one or more cardholder devices 140.

Sever computer 110 may be configured to utilize historical data on previously executed card-linked offers to determine one or more deal construct parameters. Other deal construct parameters may be provided by a requesting advertiser or by a card-linked offer provider. Server computer 110 may be further configured to determine one or more proposed deal constructs based on selected deal construct parameters, where each deal construct specifies a particular card-linked offer. For example, an advertiser may have had card-linked offers run in the past, so information related to each of the previously run card-linked offers for that advertiser may be analyzed. Here, a card-linked offer provider may have run several card-linked offers for the advertiser to different target groups of cardholders, for which the card-linked offer provider maintains an executed card-linked offer information database 120.

Similarly, the card-linked offer provider may have historical information in the executed card-linked offer information database 120 for many other advertisers, some in the same industry as the requesting advertiser and some that are not in the same industry. For example, the requesting advertiser may be a high-end coffee shop chain and the executed card-linked offer information database 120 may include historical information for previously run card-linked offers for another high-end coffee shop chain and for a high-end smoothie chain. Here, the historical data from the other high-end coffee shop chain may be the most relevant to the requesting advertiser, yet only one card-linked offer was previously run for the other coffee chain while 30 different card-linked offers were previously run for the smoothie chain, which may be in the same industry classification as the coffee chains. Thus, a predictive model module 170 may determine the relevance or weight of each previously run card-linked offer in relation to the requesting advertiser's current request criteria. For example, the predictive model module 170 may analyze 10 card-linked offers previously run for one coffee shop and provide a forecast or suggestion as to which of the 10 card-linked offers would likely provide the best performance for another coffee shop.

Server computer 110 may be further configured to deal construct parameters to provide a deal construct that specifies a proposed card-linked offer to be provided to cardholders associated with at least one card issuer. Server computer 110 may provide a set of different deal constructs as pre-set deals that are presented to the requesting advertiser. The pre-set deals may be based on a previous identification of the requesting advertiser's industry classification or designation. A non-standard deal construct may also be provided by server computer 110, where the requesting advertiser may use factors such as an average basket or ticket size to create the non-standard deal construct.

As shown in FIG. 2, an example card-linked offer system 200 may be a distributed or networked system having server computer 110 in communication with previously executed card-linked offer database 120 and deal construct parameter database 130 over a network 150. A variety of cardholder devices 140 and/or advertiser devices 160 may also be in communication with server computer 110. For example, cardholder devices 140 and/or advertiser devices 160 may include a smartphone, a laptop computer, a tablet computer, a desktop computer and the like.

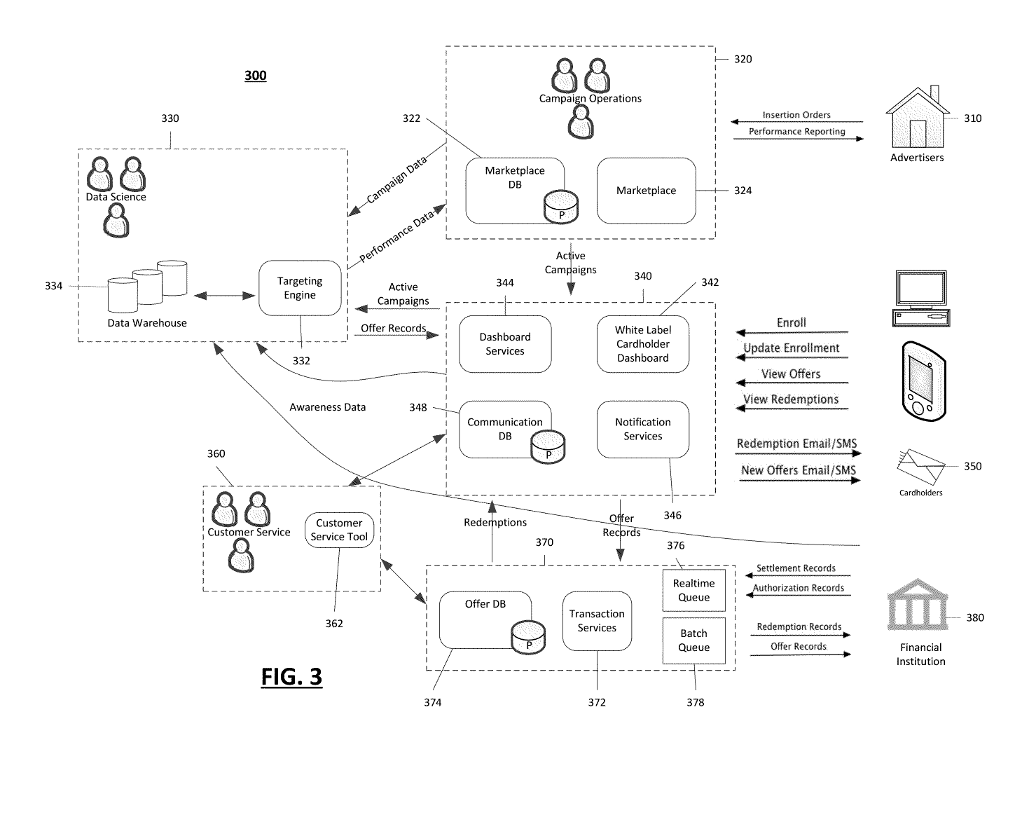

As shown in FIG. 3, an example card-linked offer system 300 may include multiple systems or modules. An advertiser 310 may interface with a campaign operations system 320 that includes a campaign operations database 322 and a marketplace module 324. For example, the advertiser 310 may provide insertion orders or submit electronic card-linked offer deals to the campaign operations system 320, and the campaign operations system 320 may provide performance reporting on the card-linked offer to the advertiser 310. The campaign operations system 320 interacts with a data science system 330 and an active campaign system 340. The data science system 330 includes a targeting engine 332 and a data warehouse 334. The campaign operations system 320 may provide campaign data to the data science system 330 and receive performance data from the data science system 330.

The active campaign system 340 includes a white label cardholder dashboard 342, a dashboard services module 344, a notification services module 346 and a communication database 348. The active campaign system 340 also interfaces with the data science system 330. For example, the active campaign system 340 may provide information on active card-linked offer campaigns and awareness data to the data science system 330, while the active campaign system 340 may receive information on offer records from the data science system 330. The active campaign system 340 also may be an interface to cardholders 350. For example, the cardholders 350 may use the active campaign system 340 to enroll, update enrollment, view offers, view redemptions, and the like. In turn, the active campaign system 340 provides information to a targeted group of cardholders 350, such as redemption emails or short message service (SMS) texts, new offer emails or SMS texts, and the like.

The active campaign system 340 also interfaces with a customer service system 360 and a transactional services system 370. The customer service system 360 includes a customer service tool module 362 and may also interface with the transactional services system 370. The transactional services system 370 includes a transactional services module 372, an offer database 374, a real time queue 376 and a batch queue 378. The transaction services system 370 may provide redemption information to the active campaign system 340, while int turn receiving offer record information from the active campaign system 340.

The transaction services system 370 also may be an interface to a financial institution 380, where the financial institution 380 provides financial cards (e.g., credit, debit) to the cardholders 350. For example, the financial institution 380 may provide information to the transaction services system 370, such as settlement records, authorization records, and the like. In return, the transaction services system 370 may provide information to the financial institution 380, such as redemption records, offer records, and the like. The financial institution 380 may also provide awareness data to the data science system 330.

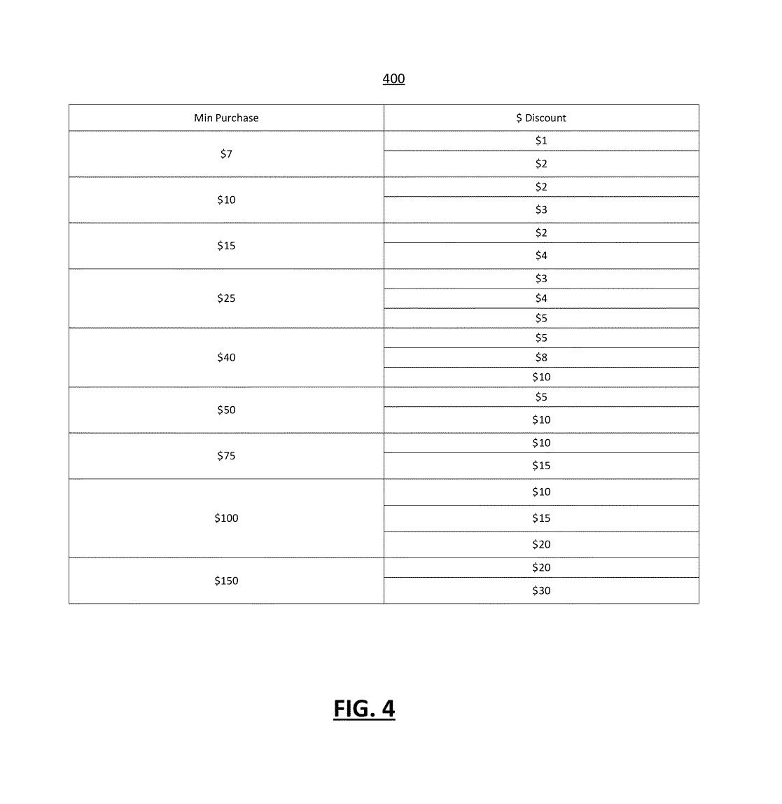

As shown in FIG. 4, a card-linked offer system may be configured to provide a deal menu 400 that lists multiple different historic deals that have been run previously. Deal menu 400 may be configured to maximize redemption rates for one or more classes of advertisers or for all advertisers. For example, deal menu 400 may list different levels of discounts for the same minimum purchase value (e.g., $1 or $2 off of a $7 purchase). Deal menu 400 may further provide multiple levels of minimum purchase value, each level having multiple levels of discounts associated with it. For example, FIG. 4 shows minimum purchase categories from $7 up to $150, each minimum purchase category having multiple discounts associated with it. A card-linked offer system may use deal menu 400 as a basis to test and define one or more best-in-case deals.

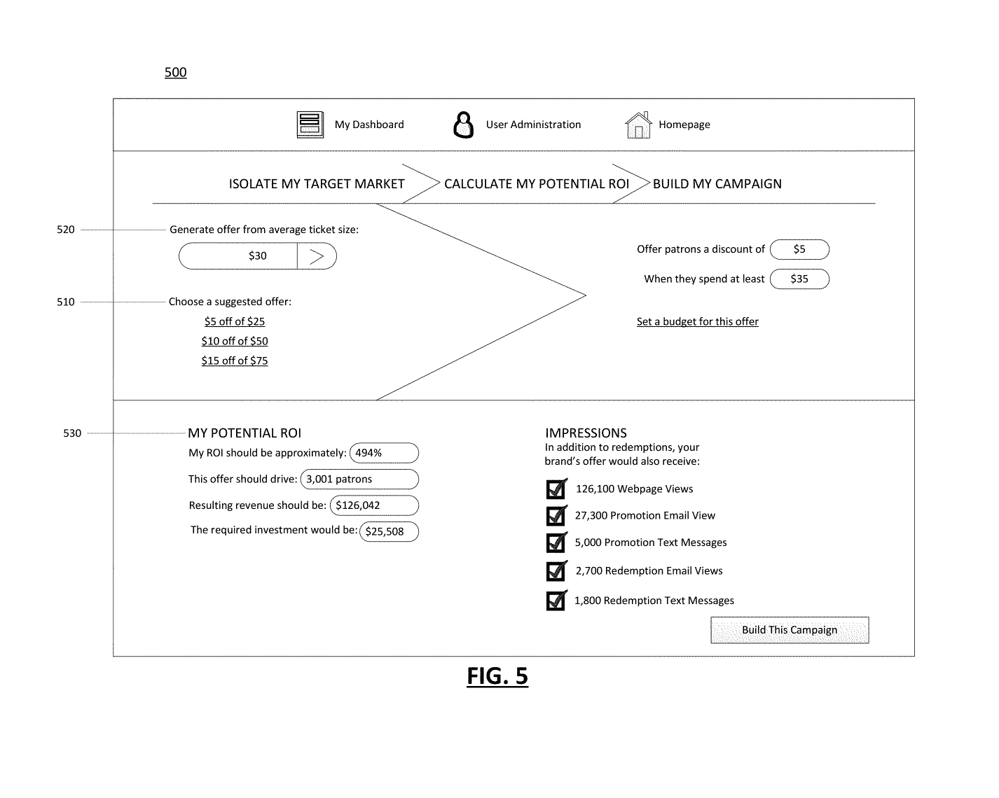

FIG. 5 illustrates an example deal construct interface 500. The deal construct interface 500 may be provided to the requesting advertiser after the advertiser's industry classification has been determined. For example, a requesting advertiser may enter an industry classification or choose from a listing of potential industry classification in a previous menu or screen. The requesting advertiser may use deal construct interface 500 to select or schedule a preferred deal construct, thereby initiating a particular card-linked offer deal to be flighted to a target group of cardholders. For example, determined deal constructs may be presented in a suggested offer section 510, with each suggested offer being a proposed deal construct that has been optimized by a card-linked offer system based on deal construct parameters associated with the requesting advertiser.

A non-standard deal construct section 520 provides for putting together a deal construct different than those provided in suggested offer section 510. Here, an average ticket or basket size may be selected as the basis for determining the non-standard deal construct. An ROI section 530 is also provided by the deal construct interface 500. ROI section 530 provides information that is estimated or forecasted by a card-linked offer system. The information provided in ROI section 530 may include an ROI percentage, number of cardholders expected, estimated revenue, a required investment, impression factors (e.g., web page views, promotion email views, promotion text messages, redemption email views, offer views, redemption text messages) and the like.

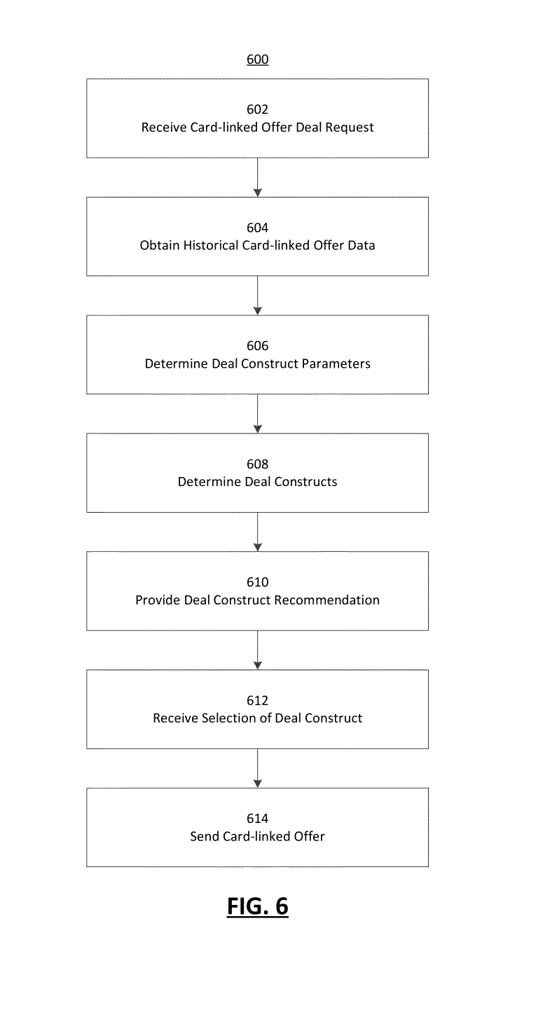

FIG. 6 illustrates an example process 600 for providing a card-linked offer based on a recommended deal construct. The process 600 begins at step 602 where a request from an advertiser is received or identified. For example, the advertiser may log in to a card-linked offer system and provide an industry classification and/or other deal based information. The entry of the information by the advertiser may be presented as a request to provide recommended deal constructs. Historical data from previously run card-linked offers may be obtained at step 604. For example, historical data from previously run card-linked offers for the same advertiser, different advertisers in the same industry, or different advertisers in other industries may be obtained from one or more databases of historical information.

At step 606, one or more deal construct parameters are determined, where at least one of the deal construct parameters is based on the historical card-linked offer data obtained in step 604. For example, deal construct parameters may include an advertiser's name, an advertiser's industry or an advertiser's geography, which may not be based on the historical card-linked offer data. Other deal construct parameters may include a historical card-linked offer performance of an advertiser, an advertiser's industry or an advertiser's geography, which may be based on the historical card-linked offer data. Determining one or more deal constructs is provided at step 608. For example, a variety of potential deal constructs may be generated based on the selected deal construct parameters. The multiple deal constructs may be provided as pre-set or standard deal constructs.

At step 610, some or all of the determined deal constructs are recommended to the requesting advertiser. For example, the recommended deal constructs may be presented to the requesting advertiser on a deal construct interface. A selection of a deal construct is received at step 612. For example, the requesting advertiser may select one of the recommended deal constructs. Alternatively, the requesting advertiser may opt not to choose a recommended deal construct, but instead may build a non-standard deal construct through the deal construct interface.

The process 600 ends at step 614 where the selected deal construct is executed, thereby sending a card-linked offer specified by the selected deal construct to a targeted group of cardholders at the appropriate date/time. Performance data from the executed card-linked offer may then be stored in a database to serve as historical card-linked offer data for use in determining future deal constructs for the same or other advertisers.

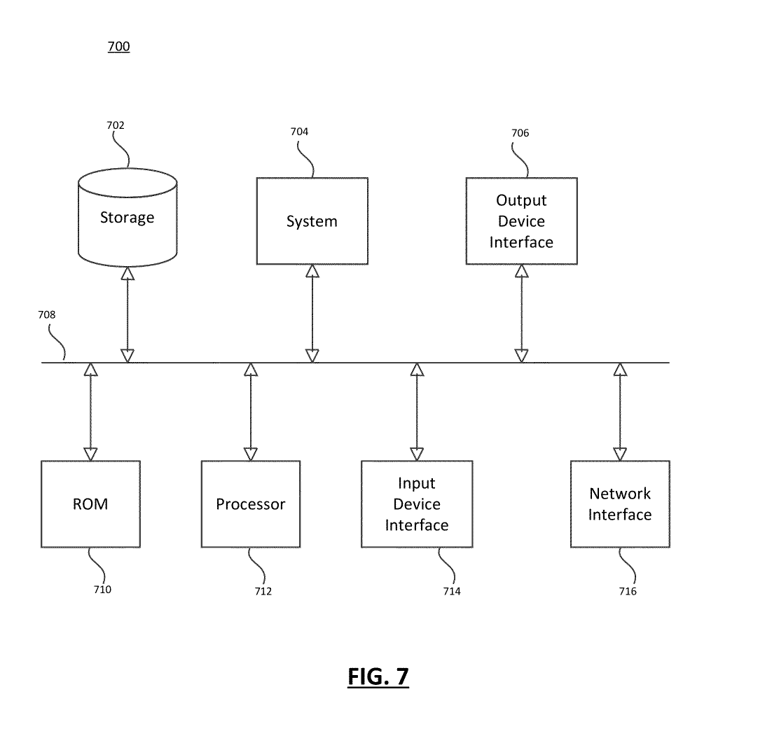

FIG. 7 conceptually illustrates an example electronic system with which some implementations of the subject technology can be implemented. Electronic system 700 can be a computer, phone, PDA, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (for example, a magnetic or optical disk and its corresponding disk drive) as permanent storage device 702.

Other implementations use a removable storage device (for example, a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, or ROM 710. For example, the various memory units include instructions for unlocking an electronic device in accordance with some implementations. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, for example, liquid crystal displays (LCD). Some implementations include devices, for example, a touchscreen that functions as both input and output devices.

Further, as shown in FIG. 7, bus 708 also couples electronic system 700 to a network (not shown) through a network interface 716. In this manner, the computer can be a part of a network of computers (for example, a local area network (“LAN”), a wide area network (“WAN”), or an Intranet, or a network of networks, for example, the Internet. Any or all components of electronic system 700 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., an LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims.

What is claimed is:

1. A computer implemented method for recommending a card-linked offer, the method comprising:
receiving, at a server, a request to create a card-linked offer deal;
obtaining, from a database, historical data from previously executed card-linked offer deals;
determining, by one or more processors, one or more deal construct parameters applicable to the requested card-linked offer deal, wherein at least one deal construct parameter is based on the historical data;
determining, by one or more processors, one or more deal constructs based on the one or more deal construct parameters, wherein a deal construct specifies a proposed card-linked offer to be provided to cardholders associated with at least one card issuer; and
recommending at least one of the determined deal constructs to the requestor.

2. The computer implemented method of claim 1, further comprising:
receiving a selection of at least one of the recommended deal constructs.

3. The computer implemented method of claim 2, further comprising:
executing, by one or more processors, the selected deal construct to send the card-linked offer specified by the selected deal construct to targeted cardholders.

4. The computer implemented method of claim 1, wherein the one or more deal construct parameters include an advertiser's identity.

5. The computer implemented method of claim 1, wherein the one or more deal construct parameters include an advertiser's industry.

6. The computer implemented method of claim 1, wherein the one or more deal construct parameters include an advertiser's geography.

7. The computer implemented method of claim 1, wherein the one or more deal construct parameters includes an advertiser's historical card-linked offer performance.

8. The computer implemented method of claim 1, wherein the one or more deal construct parameters includes a historical card-linked offer performance of an advertiser's industry.

9. The computer implemented method of claim 1, wherein the one or more deal construct parameters includes a historical card-linked offer performance of an advertiser's geography.

10. The computer implemented method of claim 1, further comprising:
assigning an industry designation to the requested card-linked offer deal, wherein the determining one or more deal constructs is based on the assigned industry designation.

11. The computer implemented method of claim 1, further comprising:
receiving an industry designation to be associated with the requested card-linked offer deal, wherein the determining one or more deal constructs is based on the assigned industry designation.

12. The computer implemented method of claim 1, wherein the determining one or more deal constructs comprises defining a set of pre-set deal constructs that are specific to an industry classification.

13. The computer implemented method of claim 1, wherein the recommending at least one of the determined deal constructs comprises providing a deal menu that maximizes historic redemption rates for an advertiser.

14. The computer implemented method of claim 1, wherein the recommending at least one of the determined deal constructs comprises providing a deal menu that tests and defines a best case deal.

15. The computer implemented method of claim 1, further comprising:
providing, by one or more processors, an average basket size configured to create a non-standard deal construct.

16. A system for recommending a card-linked offer, the system comprising:
a server computer for determining, recommending and executing a deal construct, wherein the deal construct specifies a proposed card-linked offer deal;
a first database in communication with the server computer, the first database comprising historical data from previously executed card-linked offer deals; and
a second database in communication with the server computer, the second database comprising one or more deal construct parameters,
wherein the server computer obtains historical data from the first database,
wherein the server computer assigns one or more deal construct parameters from the second database,
wherein the server computer determines one or more deal constructs associated with an advertiser based on the obtained historical data and the assigned deal construct parameters,
wherein the server computer recommends at least one of the determined deal constructs to the advertiser, and
wherein the server computer sends a communication of a card-linked offer to a target group of cardholders based on a selection of a deal construct by the advertiser.

17. The system of claim 16, further comprising:
a predictive modeling module configured to determine a recommended deal construct based on a comparison of historical card-linked offer information for another advertiser.

18. The system of claim 16, further comprising:
a third database in communication with the server computer, the third database comprising a card issuer's historical data for a group of cardholders, wherein the determining one or more deal constructs is based on the card issuer's historical data.

19. A non-transitory machine-readable storage medium comprising machine readable instructions for causing a processor to execute a method for recommending a card-linked offer, the method comprising:
receiving, by one or more processors, a request to create a card-linked offer deal;
obtaining, from a database, historical data from previously executed card-linked offer deals;
determining, by one or more processors, one or more deal construct parameters applicable to the requested card-linked offer deal;
determining, by one or more processors, one or more deal constructs based on the historical data and the one or more deal construct parameters, wherein a deal construct specifies a proposed card-linked offer to be provided to cardholders associated with at least one card issuer; and
recommending at least one of the determined deal constructs to the requestor.

20. The non-transitory machine-readable storage medium of claim 19, wherein the method further comprises:
receiving a selection of at least one of the recommended deal constructs; and
executing the selected deal construct to send the card-linked offer specified by the selected deal construct to targeted cardholders.
